(19) United States
(12) Patent Application Publication
(10) Pub. No.: US 2026/0213836 A1
(43) Pub. Date: Jul. 23, 2026

(54) Method and Apparatus for Satellite Beam Centering Control for User Scheduling

(71) Applicant: ViaSat, Inc., Carlsbad, CA (US)

(72) Inventor: James E. Petranovich, La Jolla, CA (US)

(21) Appl. No.: 19/140,111

(22) PCT Filed: Dec. 22, 2022
(86) PCT No.: PCT/US2022/053890

§ 371 Date: Jun. 17, 2025

(51) Int. Cl. H04B 7/185; H04B 7/204

(52) U.S. Cl. CPC H04B 7/18586; H04B 7/2041

(57) ABSTRACT

A satellite communications system (SCS) (20) implements a beam recentering function (32) that dynamically recenters one or more spot beams (10) with respect to their corresponding nominal beam coverage areas (40), as a component of user scheduling. Updating the beam center target (46) of a spot beam (10) can be understood as adjusting beamforming by the SCS (20) to move the beam center (14) of the spot beam (10), such that maximum signal power of the beam corresponds to different locations within the same nominal beam coverage area over time. In an example embodiment, the SCS (20) uses dynamic beam centering with respect to a plurality of forward user beams (100), with the underlying beamforming being ground-based beamforming, such as end-to-end beamforming, or being satellite-based beamforming, which may be supported by ground-based or satellite-based computation of the dynamically changing beamforming solution.

### TECHNICAL FIELD

Methods and apparatuses disclosed herein embody techniques for beam centering control in a satellite communications system, as a component of user scheduling.

### BACKGROUND

“User scheduling” refers to the handling of user traffic for a multiplicity of “users” and particularly refers to scheduling transmission resources to carry traffic for respective users in a manner that satisfies one or more scheduling goals, such as maximizing throughput, ensuring proportional fairness among the users, etc. User scheduling applies to one or both the forward-link direction where the involved communications system carries traffic towards the users and the return-link direction where the communications system carries traffic from the users.

A beamforming satellite communications system performs beamforming in the forward link to serve respective groups of user terminals in respective forward user beam coverage areas. Additionally, or alternatively, the satellite communications system performs beamforming in the return link to serve respective groups of user terminals in respective return user beam coverage areas. The return user beam coverage areas may correspond with the forward user beam coverage areas.

The forward-link direction involves the satellite communications system forming a plurality of forward user beams, which are directional radio signals. Particularly, the forward user beams may be “spot beams,” with each such spot beam being concentrated in power for focused coverage of corresponding limited geographic area.

An overall geographic area may be divided into a plurality of nominal forward user beam coverage areas, with the satellite communications system configured to generate a corresponding plurality of forward user beams that are shaped and sized for illumination of the respective nominal forward user beam coverage areas. The satellite communications system reuses combinations of signal frequencies and polarizations across the plurality of beams, to maximize use of the limited spectrum available, and performs user scheduling across the plurality of beams.

### SUMMARY

A satellite communications system (SCS) implements a beam recentering function that dynamically recenters one or more spot beams with respect to their corresponding nominal beam coverage areas, as a component of user scheduling. Updating the beam center target of a spot beam can be understood as adjusting beamforming by the SCS to move the beam center of the spot beam, such that maximum signal power of the beam corresponds to different locations within the same nominal beam coverage area over time. In an example embodiment, the SCS uses dynamic beam centering with respect to a plurality of forward user beams, with the underlying beamforming being ground-based beamforming, such as end-to-end beamforming, or being satellite-based beamforming, which may be supported by ground-based or satellite-based computation of the dynamically changing beamforming solution.

An example embodiment comprises a method of satellite beam control for a SCS comprising one or more satellite access nodes and one or more satellites. The method includes providing a plurality of spot beams, each spot beam serving a corresponding plurality of user terminals and having a corresponding nominal beam coverage area; and moving beam centers of the plurality of spot beams with respect to the corresponding nominal beam coverage areas as a component of user scheduling by the SCS. Movement of the beam centers is based on, with respect to each spot beam and with respect to each beam centering control interval in a succession of beam centering control intervals, selecting a beam center target to use for centering the spot beam. Here, the beam center target corresponds to a location in the corresponding nominal beam coverage area.

Another example embodiment comprises a SCS that includes a ground segment comprising one or more satellite access nodes and a space segment comprising one or more satellites. The one or more satellite access nodes and the one or more satellites are configured to cooperate to provide a plurality of spot beams, each spot beam serving a corresponding plurality of user terminals and having a corresponding nominal beam coverage area. Processing circuitry comprised in the SCS is configured to move beam centers of the plurality of spot beams with respect to the corresponding nominal beam coverage areas as a component of user scheduling by the SCS. Movement of the beam centers is based on, with respect to each spot beam and with respect to each beam centering control interval in a succession of beam centering control intervals, the processing circuitry being configured to select a beam center target to use for centering the spot beam. As noted, the beam center target corresponds to a location in the corresponding nominal beam coverage area.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a satellite communications system (SCS) according to an example embodiment, shown in context with a plurality of spot beams provided by the SCS for serving corresponding pluralities of user terminals.

FIG. 2 is a diagram of nominal beam coverage areas, each containing a corresponding plurality of user terminals, and each illuminated by a beam centered on a selected location.

FIG. 3 is a diagram of an example selection of a new beam center target, for a corresponding spot beam.

FIG. 4 is a logic flow diagram of a method of dynamic beam centering according to an example embodiment.

FIG. 5 is a logic flow diagram of further example details for the method of dynamic beam centering.

FIG. 6 is a block diagram of a SCS according to another example embodiment, where the SCS implements end-to-end beamforming, as a type of ground-based beamforming (GBBF).

FIG. 7 is a block diagram of example traffic processing and signal formation for end-to-end beamforming in the forward direction.

FIG. 8 is a block diagram of a SCS according to another embodiment, where a satellite performs onboard beamforming and dynamic beam centering.

FIG. 9 is a block diagram of a SCS according to another embodiment, where the ground segment implements another type of GBBF.

FIG. 10 is a diagram of sectorizing a beam area, according to one embodiment.

FIG. 11 is a logic flow diagram of a method of translating selected coverage locations into corresponding beam centers according to an example embodiment.

### DETAILED DESCRIPTION

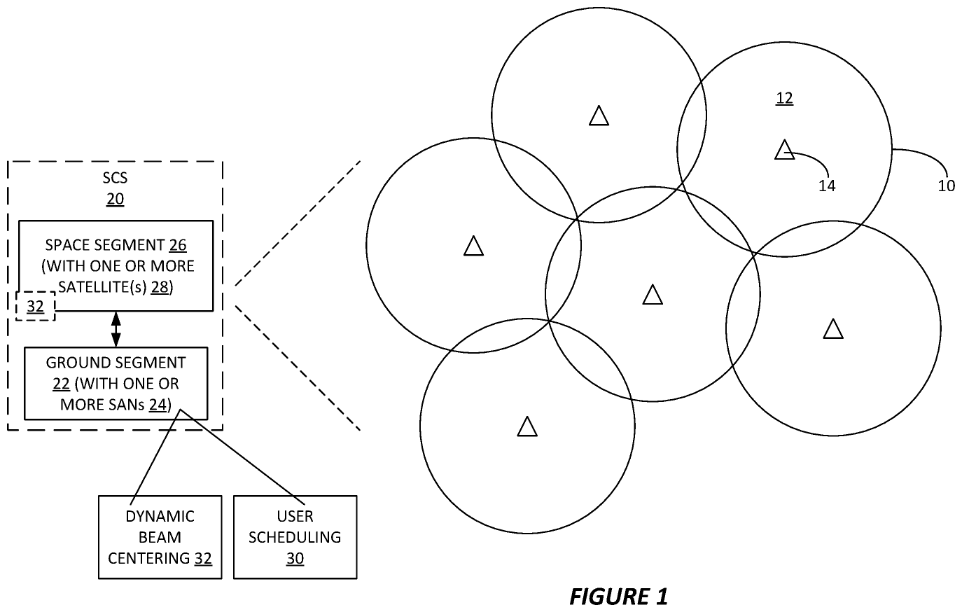

FIG. 1 illustrates a plurality of spot beams 10, where “beam” denotes the radiation pattern of electromagnetic signal energy and the word “spot” denotes a focused beam, such that a larger service area is illuminated using a potentially large plurality of individual spot beams 10. Each spot beam 10 has a cross-sectional beam area 12 and a beam center 14. Note that circular shapes of the beam areas 12 depicted in FIG. 1 are examples convenient for illustration. The actual shapes may not be circular.

A corresponding satellite communications system (SCS) 20 provides the plurality of spot beams 10. A depicted example embodiment of the SCS 20 includes a ground segment 22 that includes one or more satellite access nodes (SANs) 24. A space segment 26 includes one or more satellites 28 by or through which the plurality of spot beams 10 are provided. In at least one embodiment, the one or more satellites 28 comprise one or more geosynchronous (GEO) satellites, such as a constellation of GEO satellites.

With respect to user traffic-such as data packets-carried by the plurality of spot beams 10, the ground segment 22 includes a user scheduling function 30, which is responsible for scheduling transmissions to or from respective user terminals or groups of user terminals, among a population of user terminals served by the plurality of spot beams 10. Here and elsewhere in the specification, the word “function” denotes a particular activity or group of related activities performed by corresponding physical processing circuitry to effect an overall logical operation. As such, the user scheduling function 30 comprises circuitry configured to decide which user terminals are served during each scheduling interval in an ongoing succession of scheduling intervals.

The SCS 20 also includes a dynamic beam centering function 32, which operates as a component of the user scheduling function 30. FIG. 1 illustrates two options, with a first option being implementation of the dynamic beam centering function 32 in the ground segment 22, and with a second option being implementation of the dynamic beam centering function 32 in the space segment 26. As a further alternative, a hybrid implementation involves implementation of some of the functionality in the ground segment 22 and some of the functionality in the space segment 26. Regardless of the details for implementation of the beam centering function 32, dynamic beam centering means moving the beam center 14 of one or more of the plurality of spot beams 10 as a component of user scheduling.

For example, the beam center 14 of a spot beam 10 is moved from time to time, to change where the spot beam 10 is focused within a nominal beam coverage area. As a particular example, assuming that user terminals are distributed within the nominal beam coverage area, the beam center 14 is moved to reflect which user terminal(s) or subsets of user terminals are being served by the spot beam 10 during any given scheduling interval. Moving the beam center 14 can be understood as adjusting the beamforming parameters with the intent of improving the Signal-to-Noise Ratio (SNR) of the scheduled user terminals. In a geosynchronous example where the spot beams 10 normally are fixed, the dynamic beam centering imparts a slight movement or shifting of beam foci in concert with user scheduling, with the aim of improving signal conditions of scheduled users.

The beam area 12 of a given spot beam 10 may be defined according to contour lines reflecting radiated power levels, with the perimeter of the spot beam 10 defined as the −3 dB contour line, for example. Here, −3 dB represents the falloff in radiated power relative to the maximum signal power within the beam area 12. Power may be expressed in terms of Equivalent Isotropic Radiated Power or EIRP. The beam center 14 represents the location within the beam cross section at which radiated power is at its maximum. Depending upon the beam shape and the implementation details, the beam center 14 is not necessarily the geometric center or centroid of the beam cross section.

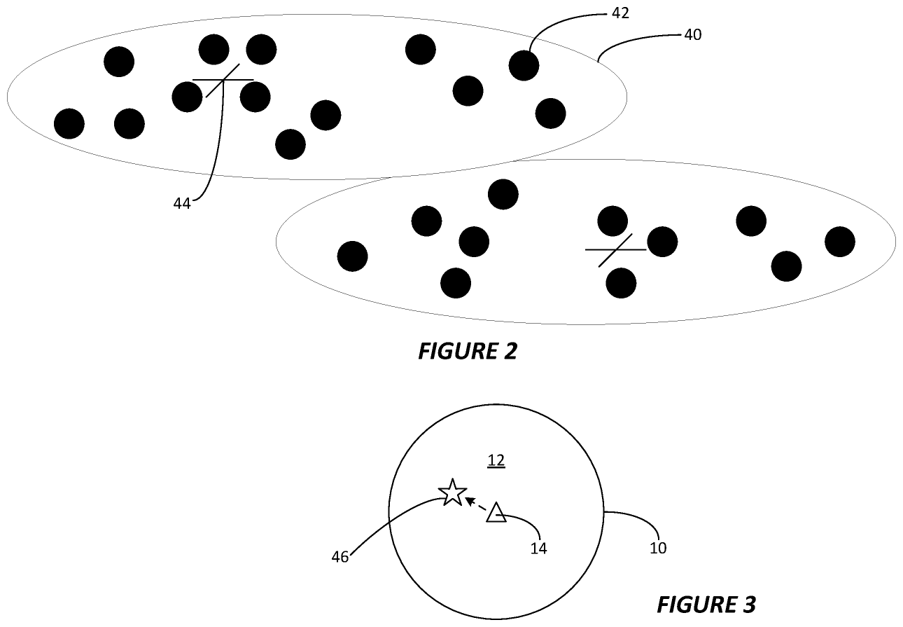

FIG. 2 depicts an example arrangement that includes two nominal beam coverage areas 40, which are defined geographic regions. Of course, there may be many nominal beam coverage areas 40 in practice and dynamic beam centering may be used for one or more of them.

Each spot beam 10 has a corresponding beam footprint on the surface of the Earth, which depends on the beam area 12 and the beam angle. The beam footprint may also be referred to as a beam coverage area and, correspondingly, a “nominal beam coverage area 40” may be understood as a default or predefined ground area targeted for illumination by a corresponding spot beam 10.

A large geographic service area may be illuminated using a plurality of spot beams 10, with each spot beam 10 at least nominally oriented for illumination of a corresponding one among a plurality of nominal beam coverage areas 40 that subdivide the overall geographic service area. For example, with the satellite 28 operating as a GEO satellite, each spot beam 10 may be a nominally stationary or fixed beam-absent perturbations or systemic errors-that provides correspondingly consistent illumination of a respective nominal beam coverage area 40.

Each nominal beam coverage area 40 includes one or more user terminals 42, for example. At different times, a different location 44 within each nominal beam coverage area 40 may be selected for targeting the beam center 14 of corresponding spot beam 10. For example, it may be that there are “clusters” (geographic groupings) of user terminals 42 within a nominal beam coverage area 40 and the user scheduling function 30 imposes a time-multiplexing scheme where user traffic associated with particular clusters is temporally grouped. Correspondingly, the beam centering function 32 dynamically moves the beam center 14 of the corresponding spot beam 10, to focus the spot beam 10 on each respective cluster during the scheduling interval(s) during which the spot beam 10 carries traffic for the respective cluster. As another example, each nominal beam coverage area 40 is subdivided into sectors and the center coordinates of different sectors are chosen at different times as the selected locations 44 to use for defining the beam center targets of the involved spot beams 10.

For any given selected location 44, the geographic coordinates of the selected location 44 may be translated into a beamforming coordinate system, which may be based on azimuthal and elevational angles, to define a beam center target for the involved spot beam 10. FIG. 3 illustrates an example scenario where a beam center target 46 is offset from a current beam center 14, and where the beamforming solution-beamforming weights-used to form the illustrated spot beam 10 are adjusted, to move the beam center 14 to the beam center target 46. With respect to the corresponding nominal beam coverage area 40, each selection of a new location 44 results in the re-computation of beamforming weights for the involved spot beam 10, to “move” the beam center 14 to the beam center target 46 corresponding to the newly selected location 44.

As noted, each nominal beam coverage area 40 includes a plurality of user terminals 42 served by the spot beam 10 that corresponds to the nominal beam coverage area 40. The distribution pattern of user terminals 42 may be different in each nominal beam coverage area 40 and may change over time. For example, the user terminals 42 located within any given nominal beam coverage area 40 may comprise stationary terminals or mobile terminals or a mix of both. However, with respect to moving the beam centers 14, mobile terminals are presumed to change location relatively slowly in comparison to the rate at which beam-centering changes are decided.

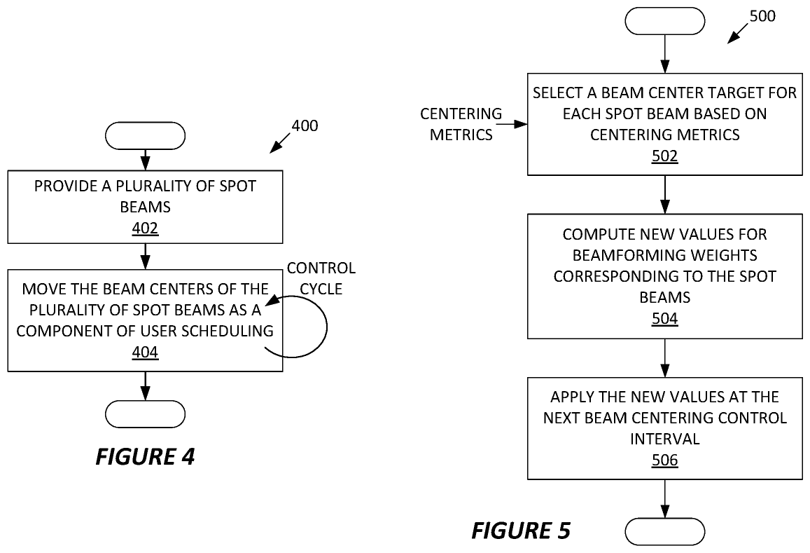

FIG. 4 illustrates an embodiment comprising a method 400 of satellite beam control for a SCS 20 comprising one or more satellite access nodes 24 and one or more satellites 28. The method 400 includes providing (Block 402) a plurality of spot beams 10, each spot beam 10 serving a corresponding plurality of user terminals 42 and having a corresponding nominal beam coverage area 40; and moving (Block 404) beam centers 14 of the plurality of spot beams 10 with respect to the corresponding nominal beam coverage areas 40 as a component of user scheduling by the SCS 20. Moving the beam centers 14 comprises, with respect to each spot beam 10 and with respect to each beam centering control interval in a succession of beam centering control intervals, selecting a beam center target 46 to use for centering the spot beam 10, the beam center target 46 corresponding to a location 44 in the corresponding nominal beam coverage area 40.

The “providing” step (Block 402) may be understood as operating the SCS 20 in such a way as to form the spot beams 10. As an example, “providing” refers to ongoing performance of beamforming by the SCS 20. Correspondingly, the “moving” step (Block 404) may be understood as an ongoing or repeating operation, such as updating the beamforming weights that are used in the SCS 20 to provide the plurality of spot beams 10.

The corresponding nominal beam coverage area 40 of each spot beam 10 is logically divided into a plurality of sectors, according to one or more embodiments. The beam center target 46 for each spot beam 10 in each beam centering control interval corresponds to a selected one of the sectors. At least one such embodiment includes selecting the sectors on a round-robin basis, and, with respect to each round-robin selection cycle, controlling the length of time individual ones of the sectors remain selected based on communication needs of user terminals 42 located in the individual sectors.

With respect to each beam centering control interval, selecting the beam center target 46 to use for centering each spot beam 10 includes, in at least one embodiment, selecting a location 44 in the corresponding nominal beam coverage area 40 in dependence on at least one of: a spatial distribution of the corresponding plurality of user terminals 42 within the corresponding nominal beam coverage area 40; or respective communication needs of the corresponding plurality of user terminals 42 within the corresponding nominal beam coverage area 40. In at least one embodiment, the pattern of location selection within each corresponding nominal beam coverage area 40 over multiple ones of the beam centering control intervals is a function of a user scheduling algorithm implemented by the SCS 20. For example, the method 400 may include identifying clusters of user terminals 42 within each nominal beam coverage area 40, and, over time, selecting different locations 44 corresponding to different identified clusters as the beam center target 46 for the spot beam 10 corresponding to the nominal beam coverage area 40.

In one or more embodiments, the method 400 includes aligning boundaries of the beam centering control intervals with boundaries of transmission slots used by the SCS 20 for transmissions of user traffic. Doing so ensures that movement of the beam center 14 of any spot beam 10 among the plurality of spot beams 10 occurs only on transmission slot boundaries. As one example, the SCS 20 organizes transmissions based on a frame structure, where each frame in a continuing succession of frames comprises a defined number of subframes, with each subframe comprising one or more time slots that serve as Transmission Time Intervals (TTIs) representing the smallest allocable unit of time for scheduling transmissions to or from respective user terminals 42.

In at least one embodiment, moving beam centers 14 of the plurality of spot beams 10 includes, during any current beam centering control interval, selecting a next beam center target 46 for each spot beam 10 with respect to a next beam centering control interval and, for any spot beam 10 in which the next beam center target 46 selected for the next beam centering control interval differs from a current beam center target 46 selected for the current beam centering interval, adjusting beamforming performed by the SCS 20 at the beginning of the next beam centering control interval to move the beam center 14 of the spot beam 10 to the next beam center target 46.

Moving the beam center 14 of any one among the plurality of spot beams 10 comprises, in one or more embodiments, computing new values for a corresponding set of beamforming weights used by the SCS 20 to produce radiated signal superpositions resulting in the spot beam 10. The SCS 20 performs beamforming, for example, to provide the plurality of spot beams 10, with each spot beam 10 having a corresponding set of beamforming weights used by the SCS 20. As a particular example, the SCS 20 performs end-to-end beamforming in the forward direction, wherein the plurality of spot beams 10 comprises a plurality of forward user beams that are realized using end-to-end beamforming. See U.S. Pat. No. 10,720,988 B2 issued on 2020-07-21, for example details regarding end-to-end beamforming Other approaches to ground-based beamforming may be used, such as transmitting weighted beam element signals to the satellite 28, for transmission from corresponding antenna elements of an onboard phased array antenna. Yet other approaches include transmitting forward beam signals with corresponding weighting information from the ground segment 22, for application of the weights via beamforming circuitry onboard the satellite 28. At least one embodiment relies on a wholly onboard implementation in which the satellite 28 computes beamforming weights and applies them to the forward beam signals for transmission from an onboard phased array antenna.

In any case, for each forward user beam for which the corresponding beam center 14 is moved to a new beam center target 46, the method 400 includes computing new values for the involved beamforming weights. Here, the new values are computed to optimize a signal-to-noise ratio (SNR) at the new beam center target 46, and to minimize other-beam interference at the new beam center target 46. Put another way, with any given beam center target 46 corresponding to a selected location 44 within the nominal beam coverage area 40 corresponding to the involved spot beam 10, realizing the beam center target 46 means computing beamforming weights that optimize SNR for the user terminal(s) at or proximate to the selected location 44.

For any beam centering control interval for which one or more beam centers 14 are moved, the method 400 comprises, in one or more embodiments, computing new values for all beamforming weights corresponding to all spot beams 10, to account for changes in inter-beam interference arising from the moved beam center(s) 14. That is, there are beamforming weights corresponding to each spot beam 10 and all such weights in the aggregate represent an overall beamforming solution implemented by the SCS 20, and the SCS 20 performs a joint optimization of the beamforming solution for any given collection of beam center targets 46 decided for a given beam centering control interval. The joint optimization limits inter-beam interference and correspondingly maximizes the respective beam-signal SNRs at the respective beam center targets 46.

In at least one embodiment, the duration of the beam centering control intervals is an integer multiple of the duration of user scheduling intervals used by the SCS 20. The boundaries of the beam centering control intervals align with boundaries of the user scheduling intervals, such that movement of the beam centers 14 is restricted in a temporal sense to the transitions from one user scheduling interval to the next.

Although re-computation of the overall beamforming solution may be a joint function of the overall set of beam center targets 46 to be used for any given beam centering control interval, the individual beam center targets 46 may be chosen independently. However, in at least one embodiment, the method 400 includes applying spatial limits to the selection of beam center targets 46, to restrict spot beam overlap between adjacent spot beams 10 that are at a same frequency.

FIG. 5 illustrates a method 500 of operation by the beam centering function 32 and can be understood as example details for Block 402 in FIG. 4. The method 500 may be looped or otherwise performed on an ongoing basis and, in general, the operations detailed in FIGS. 4 and 5 may be performed on an ongoing basis, along with other operations by the SCS 20.

FIGS. 4 and 5 may be subsumed in or performed in conjunction with user scheduling in which the SCS schedules transmissions to and/or from respective user terminals 42 or groups of user terminals 42. Such scheduling may be performed on per-beam basis, although scheduling may also consider overall system capacity and bandwidth limits, which may involve sharing of certain system resources across the spot beams 10.

Operations in the method 500 include, for each beam centering control interval, selecting (Block 502) a beam center target 46 for each spot beam 10, based on centering metrics. Example centering metrics may be determined by the beam centering function 32 or the user scheduling function 30 and may comprise information indicating respective locations 44 in the nominal beam coverage areas 40 to use as the beam center targets 46 in dynamic beam recentering. Other example metrics include any one or more of information about the spatial distribution of user terminals 42 in each nominal beam coverage area 40, information about the communication services or service types associated with the respective user terminals 42 in each nominal beam coverage area 40, information about the communication needs or communication statistics of the respective user terminals 42 in each nominal beam coverage area 40. Such information comprises, for example, Quality-of-Service (QOS) requirements, such a minimum throughput, etc. In general, the beam center targets 46 may be moved over successive beam centering control intervals according to a user scheduling algorithm, such as a proportionally fair scheduling algorithm that decides which user terminals 42 are scheduled in dependence on one or more weighting parameters that control the proportionality, subject to some floor or baseline limit to prevent “unfairness” or to meet some minimum requirements.

In at least one embodiment, the centering metrics comprise information indicating the selected locations 44 for the plurality of nominal beam coverage areas 40 for a next beam centering control interval, and the beam centering function 32 uses that information to compute new beam center targets 46. It may be that the “new” beam center target 46 selected for any given spot beam 10 for any given upcoming beam centering control interval is the same as the one being used for the current beam centering control interval. In such cases, for such spot beams 10, the beam center targets 46 will not change when the next beam centering control interval begins. In other words, the beam center targets 46 do not necessarily change for every single spot beam 10 in every single beam centering control interval.

With new beam center targets 46 selected for one or more of the spot beams 10, the method 500 continues with computing (Block 504) new values for respective beamforming weights corresponding to the spot beams 10. Computing new beamforming weights for any one or more of the spot beams 10 may be referred to as “updating” or “adjusting” the beamforming solution, where, as noted, the term “beamforming solution” refers to the overall sets or plurality of beamforming weights used to realize the plurality of spot beams 10.

In at least one embodiment, there are predefined sets of beam center targets 46 for the plurality of spot beams 10, and these are indexed or mapped to corresponding pre-computed beamforming solutions, such that the beamforming solutions do not need to be computed on the fly and instead are retrieved from a look-up table or other stored data structure. Because such solutions are less flexible than on-the-fly computation, they may be more advantageous in embodiments where the nominal beam coverage areas 40 are sectorized according to a known division scheme, and where the selected locations 44 are restricted to the defined sectors.

Whether the new values are precomputed or computed on the fly, the method 500 continues with applying (Block 506) the new values at the next beam centering control interval. As noted, in one or more embodiments, the movement of any beam center 14 of any spot beam 10 involves recomputing the beamforming weights for all spot beams 10. Such re-computation of the beamforming solution reflects a joint optimization of the beamforming weights for all spot beams 10, for reducing inter-beam interference and correspondingly maximizing SNR at respective beam center targets 46 of all spot beams 10.

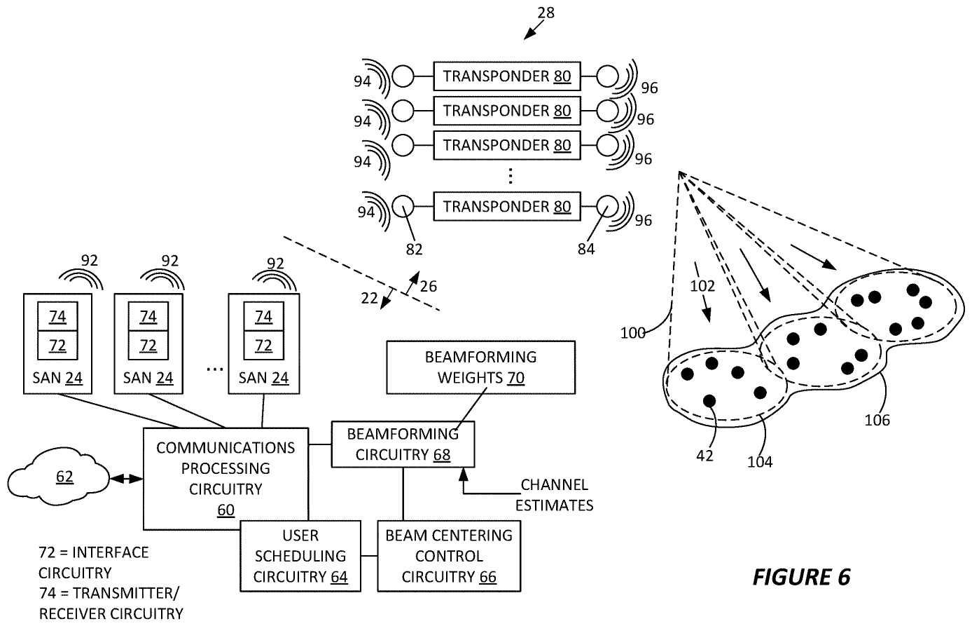

FIG. 6 illustrates the SCS 20 according to an example embodiment that uses end-to-end beamforming and where the ground segment includes one or more SANs 24, supported by communications processing circuitry 60, which may be implemented in one or more nodes, e.g., one or more computer servers. The communications processing circuitry 60 interfaces with one or more external networks 62, such as the Internet or other Packet Data Networks (PDNs), the Public Switched Telephone Network (PSTN), etc. User traffic targeting respective user terminals 42 served by the SCS 20 flows into the communications processing circuitry 60 from the external network(s) 62, and user traffic originating from respective user terminals 42 served by the SCS 20 flows out from the communications processing circuitry 60 into the external network(s) 62.

The communications processing circuitry 60 includes or interfaces with user scheduling circuitry 64 and beam centering control circuitry 66. Further, the communications processing circuitry 60 includes or interfaces with beamforming circuitry 68. The beamforming circuitry 68 computes and applies beamforming weights 70 for the forward-link direction towards the user terminals 42 or for the return-link direction from the user terminals 42 or for both directions. The beamforming circuitry 68 computes the beamforming weights 70 based on channel estimates. The beamforming weights 70 comprise, for example, a set of forward beamforming weights and a set of return beamforming weights.

Each SAN 24 includes interface circuitry 72 for communicating with the communications processing circuitry 60, in the forward and return directions. The interface circuitry 72 includes circuitry configured for physical-layer signal reception and transmission via a wired or wireless medium and may include higher-layer circuitry for protocol processing, synchronization, etc. Further, each SAN 24 includes transmitter/receiver circuitry 74. In at least one embodiment, the transmitter/receiver circuitry 74 comprises radiofrequency (RF) transmitters and receivers for providing RF-based feeder uplinks and downlinks between each SAN 24 and the satellite 28.

An example satellite 28 includes a plurality of transponders 80, with each transponder 80 providing a respective signal pathway through the satellite 28. There may be transponders 80 dedicated to the forward-link direction, providing forward-link signal pathways for relaying forward user traffic from the ground segment 22 towards the user terminals 42, and a separate plurality of transponders 80 dedicated to the return-link direction, providing return-link signal pathways for relaying return user traffic from the user terminals 42 to the ground segment 22. In other embodiments, the same plurality of transponders 80 provides forward-link signal pathways and return-link signal pathways on a time-multiplexed, switched basis. In other arrangements, the plurality of transponders 80 includes at least some that have switchable connections, allowing for their use in either the forward direction or the return direction.

Using the illustrated forward-link direction for example context, each transponder 80 has an input (receive) end associated with a receive antenna element 82 and has an output (transmit) end associated with a transmit antenna element 84. There may be corresponding antenna subsystems onboard the satellite 28 dedicated for reception in the forward and/or return directions and further antenna subsystems dedicated for transmission in the forward and/or return directions. In the return direction in at least the end-to-end beamforming context, the “input” end of a transponder 80 receives superpositions of return uplink signals from user terminals 42 operating in one or more return beam coverage areas, which may or may not be coincident with the forward beam coverage areas. Correspondingly, the “output” end of the transponder transmits the received superposition of return uplink signals as a corresponding return downlink signal that is received at two or more of the SANs 24.

For end-to-end beamforming in the forward direction, the communications processing circuitry 60 forms, under control of the user scheduling circuitry 64, a forward user stream. Each forward user stream multiplexes forward user traffic for respective user terminals 42 in a particular one of the nominal beam coverage areas 40, according to operation of the user scheduling circuitry 64. Hence, each forward user stream can be understood as conveying forward user traffic for transmission via a corresponding one among the plurality of spot beams 10.

The beamforming circuitry 68 uses end-to-end channel estimates for the forward direction to compute beamforming weights for forward beamforming as a M×K matrix of beamforming weights. Here, M equals the number of SANs 24 participating in the end-to-end beamforming and K equals the number of forward user beams. Each forward user stream is used to form a forward beam signal, meaning that there are K forward beam signals, with each one conveying forward user traffic for transmission in a respective one of the K forward user beams.

The beamforming circuitry 68 applies the values of the M×K beam weight matrix to each of the K forward beam signals to generate M access node specific forward signals. Each one of the access node specific forward signals corresponds to a particular one of the M SANs 24, and each comprises K weighted forward beam signals. The beamforming circuitry 68 may include a splitting module and M forward weighting and summing modules. The splitting module splits (e.g., duplicates) each of the K forward beam signals into M groups of K forward beam signals, with one group for each of the M forward weighting and summing modules.

Accordingly, each forward weighting and summing module receives all K forward beam signals. Here, “module” refers to configured circuitry.

Further, circuitry within the beamforming circuitry 68 operates as a forward beam weight generator module that generates the M×K forward beam weight matrix. In one or more embodiments, the forward beam weight matrix is generated based on a channel matrix in which the elements are estimates of end-to-end forward gains for each of the K×M end-to-end forward multipath channels to form a forward channel matrix. Estimates of the end-to-end forward gain are made in a channel estimator module.

Thus, in the forward-link direction, each SAN 24 receives one of the M access node specific forward signals, for transmission by the SAN 24 as a forward uplink signal 92. Each receive antenna element of the satellite 28 receives a unique superposition of the forward uplink signals 92, with each such superposition involving the forward uplink signals 92 from two or more of the M SANs 24. The superpositions are unique because the SANs 24 are geographically distributed, resulting in a different uplink channel between each SAN 24 and each receive antenna element 82 on the satellite 28.

The unique superposition of forward uplink signals 92 received at each receive antenna element 82 may be referred to as a forward composite uplink signal 94, meaning that the input end of each of the transponders 80 receives a unique forward composite uplink signal 94. Each transponder 80 operates as a non-processed, bent-pipe transponder that couples the correspondingly received forward composite uplink signal 94 to the user downlink side of the satellite 28, for transmission as a forward user downlink signal 96 from a corresponding one of the transmit antenna elements 84. The forward user downlink signals 96 are the corresponding forward composite uplink signals 94, subject to filtering, amplification, and, in one or more embodiments, frequency translation from uplink signal frequencies to downlink signal frequencies.

The plurality of transmit antenna elements 84 are configured such that the respective forward user downlink signals 96 transmitted from the different transmit antenna elements 84 superpose in the far field—i.e., at distances from the transmit antenna elements 84 at which radiative behavior of the electromagnetic signals dominates. These superpositions form a plurality of forward user beams 100, each being the beamformed transmission of a forward beam signal 102 and each having a corresponding forward user beam coverage area 104. The aggregation of forward user beams 100 illuminates an overall forward user service area 106. It shall be appreciated that the forward user beams 100 are an example of the spot beams 10 discussed herein.

Each forward user beam 100 illuminates a respective forward user beam coverage area 104 and there may be predefined or default geographic coordinates or boundaries that nominally define the specific region on the surface of the Earth that is illuminated—i.e., there may be a defined nominal beam coverage area 40 for each forward user beam 100.

Correspondingly, the dynamic beam recentering described herein can, in this example context, be understood as dynamically recentering one, some, or all the forward user beams 100 with respect to each beam centering control interval. Each forward user beam 100 may be understood as the beamformed transmission of a forward beam signal 102, which multiplexes user traffic for user terminals 42 served by the forward user beam 100, according to ongoing user scheduling.

The communications processing circuitry 60 includes or is communicatively associated with the user scheduling circuitry 64, the beam centering control circuitry 66, and the beamforming circuitry 68. All such circuitry comprises fixed circuitry or programmatically configured circuitry or a mix of both. For example, at least some of the beamforming circuitry 68 comprises Digital Signal Processing (DSP) hardware configured to carry out the beamforming computations. Further at least some of the circuitry depicted in FIG. 6 comprises one or more microprocessors or DSPs or other programmatically configured digital processing circuitry that is specially adapted to carry the described functions, based on executing computer program instructions stored in a computer readable medium. For example, the communications processing circuitry 60 includes or is associated with one or more types of storage, such as RAM for working program execution and FLASH for non-volatile storage of the program instructions. Such storage is also used for storing the beamforming weights 70 and the channel estimates.

The channel estimates may be determined from Channel State Information (CSI). One approach to providing CSI feedback relies on one or more user terminals 42 operating in each nominal beam coverage area 40 as “reference terminals” (RTs) or “designated terminals” (DTs). For example, one or more user terminals 42 that are at or proximate to the geographic center of the nominal beam coverage area 40 may be RTs. Such an approach involves receiving downlink channel estimates from respective RTs for each nominal user coverage area 40, based on each SAN 24 transmitting a unique reference signal, for use in channel estimation at the RTs.

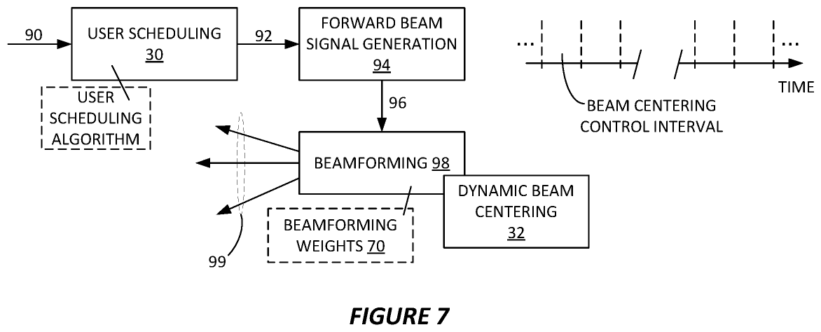

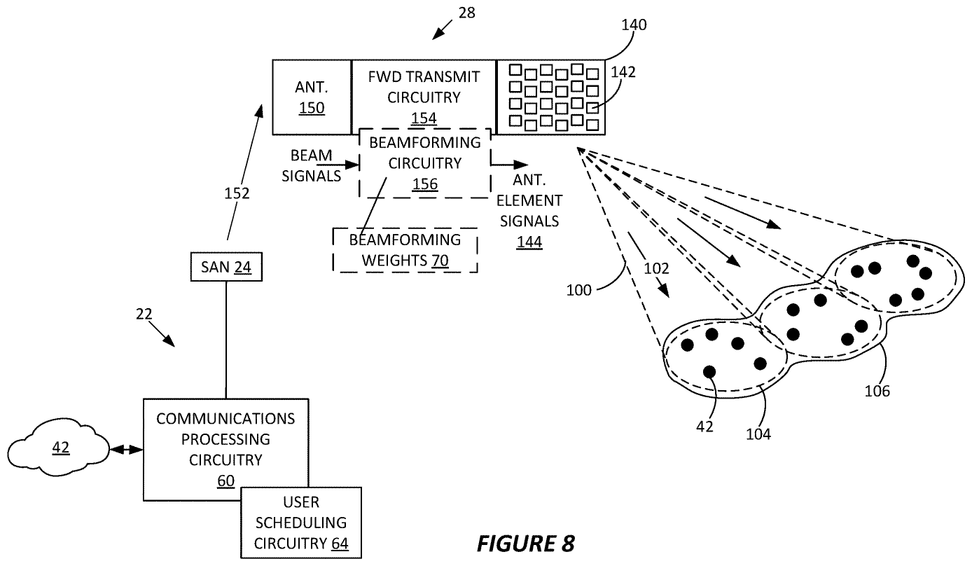

FIG. 7 illustrates an example of end-to-end beamforming in the forward direction, in terms of example functions. Incoming forward user traffic 90 is scheduled, e.g., based on determining the identities of the user terminals 42 targeted by given portions of the traffic, determining the nominal beam coverage areas 40 associated with the targeted terminals and forming corresponding forward stream signals 92. A forward beam signal generation function 94 outputs forward beam signals 96 corresponding to the forward stream signals 92 and a beamforming function 98 applies the beamforming weights 70 to the forward beam signals 98, e.g., applies a M×K forward weight matrix as described above, to create a set of M access node specific forward signals 99, each one generated for a particular one of the SANs 24 participating in the end-to-end beamforming. Note that the beamforming weights 70 are adapted with respect to each beam centering control interval, to reflect beam center targets 46 applicable to each beam centering control interval.

FIG. 8 illustrates an alternative embodiment to beamforming. Here, beamforming is based on the satellite 28 having a phased array antenna 140 onboard, comprising a plurality of antenna elements 142 arranged in a feeder plane. Although not shown, there may be a reflector onboard the satellite 28, associated with the phased array antenna 142. With this arrangement, there is a plurality of antenna element signals 144, each one corresponding to a respective antenna element. The antenna element signals 144 are weighted such that their transmission results in signal superpositions that form forward user beams 100, as examples of the spot beams 10 discussed herein.

In one embodiment, the satellite 28 includes an antenna subsystem 150 by which it receives a forward uplink signal 152 comprising one or more forward beam signals. The antenna subsystem 150 couples the received forward uplink signal 152 to forward transmit circuitry 154, which includes beamforming circuitry 156.

The beamforming circuitry 156 forms the antenna element signals 124 based on dividing each forward beam signal into N unweighted element signals, where N equals the number of antenna elements 122, and then applying a corresponding set of beamforming weights. Each such set provides for formation of a respective one of the forward user beams 100 and it comprises a respective beam weight-phase and/or amplitude-for each antenna element 142.

There may be multiple phased array antennas 140, e.g., associated with different downlink signal frequencies and/or polarizations, or the phased array antenna 140 may include multiple sets of input antenna feeds, corresponding to different downlink signal frequencies and/or polarizations. As a further note, the beamforming circuitry 156 may form a set of antenna element signals 144 for each forward beam signal and combine those sets that correspond to forward user beams 100 having the same downlink signal frequency and polarization. The beamforming circuitry 156 in one or more embodiments is configured to compute the beamforming weights 70, and may incorporate the beam centering function 32, such that the beamforming weights 70 are adjusted for dynamic movement of the beam centers 14. As an alternative, the communications processing circuitry 60 may incorporate processing circuitry configured as a beamforming weight calculator that computes the beamforming weights 70, including dynamic adjustments for beam centering control intervals, for transmission to the satellite 28 and corresponding application by the beamforming circuitry 156 onboard the satellite.

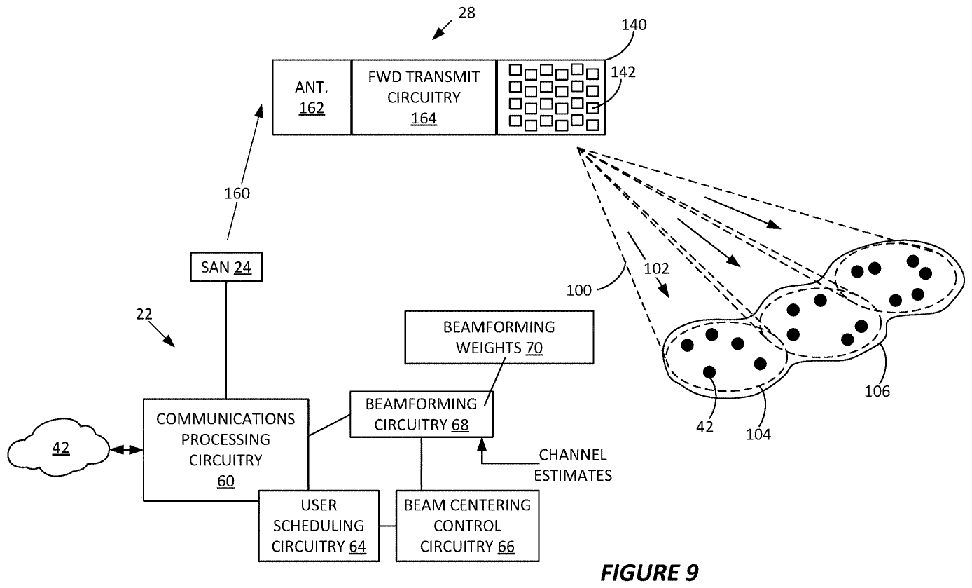

FIG. 9 illustrates another embodiment in which the beamforming weights 70 are computed on the ground and applied on the ground. With this approach, the ground segment 22 forms forward user beams, each corresponding to one of the forward user beams 100, splits each forward user beam into N beam element signals, each beam element signal corresponding to an antenna element 142 in a phased array antenna 140 onboard the satellite 28 and weighted such that simultaneous transmission of the beam element signals from the phased array antenna 140 forms corresponding forward user beams 100.

A SAN 24 forms a forward uplink signal 160 that conveys the forward beam element signals towards the satellite 28, which includes an antenna subsystem 162. Forward transmit circuitry 164 provides filtering, amplification, and, in one or more embodiments, frequency conversion. The forward transmit circuitry 164 couples the forward beam element signals to the respective antenna elements 142, for transmission.

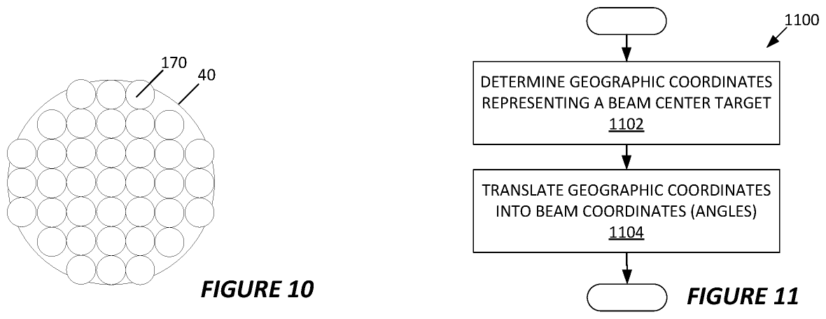

FIG. 10 illustrates an example of logically dividing a nominal beam coverage area 40 into a plurality of sectors 170. Each sector 170 may be represented by defined geographic coordinates representing the sector center or other reference point associated with the sector.

Different ones of the reference points for any given nominal beam coverage area 40 may be selected individually, as the locations 44 for calculating the beam center targets 46 for the involved spot beam 10, over successive beam centering control intervals.

FIG. 11 illustrates a method 1100 used for translating any given selected location 44 into a beam center target 46. The method 1100 includes determining (Block 1102) geographic coordinates representing a beam center target-i.e., a location 44 within a given nominal beam coverage area 40 is selected for a given beam centering control interval, where the geographic coordinates of the selected location 44 are already known or are determined on the fly. The method 1100 continues with translating (Block 1104) the geographic coordinates into beam coordinates, e.g., angular values that are used for recomputing the corresponding beam weights, to effect a recentering of the involved spot beam 10.

With the above examples in mind, a SCS 20 in an example embodiment includes a ground segment 22 comprising one or more SANs 24 and a space segment 26 comprising one or more satellites 28. The one or more SANs 24 and the one or more satellites 28 are configured to cooperate to provide a plurality of spot beams 10. Each spot beam 10 serves a corresponding plurality of user terminals 42 and has a corresponding nominal beam coverage area 40.

Processing circuitry included in the SCS 20 is configured to move beam centers 14 of the plurality of spot beams 10 with respect to the corresponding nominal beam coverage areas 40 as a component of user scheduling by the SCS 20, based on, with respect to each spot beam 10 and with respect to each beam centering control interval in a succession of beam centering control intervals, selecting a beam center target 46 to use for centering the spot beam 10, the beam center target 46 corresponding to a location 44 in the corresponding nominal beam coverage area 40.

In one or more embodiments, such processing circuitry resides in the ground segment 22, see the beam centering control circuitry 66 in FIG. 6, for example. In one or more other embodiments, such processing circuitry resides in the space segment 26, see the beamforming circuitry 136 in FIG. 8, for example, which, in one or more embodiments, implements the dynamic beam centering function 32 discussed herein. In yet other embodiments, the dynamic beam centering function 32 is realized cooperatively between the ground segment 22 and the space segment 26, such as by re-computing beamforming solutions in the ground segment 22 for dynamic beam centering and applying those beamforming solutions in the space segment 26.

In one or more embodiments, the one or more satellites 28 include a geostationary satellite that is used to provide the plurality of spot beams 10 as nominally stationary spot beams corresponding to the nominal beam coverage areas 40. The corresponding nominal beam coverage area 40 of each spot beam 10 is divided logically into a plurality of sectors 170, and the beam center target 46 for each spot beam 10 in each beam centering control interval corresponds to a selected one of the sectors 170. Correspondingly, in at least one embodiment, the processing circuitry in the SCS 20 that performs dynamic beam centering is configured to select the sectors 170 on a round-robin basis, and, with respect to each round-robin selection cycle, control the length of time individual ones of the sectors 170 remain selected based on communication needs of user terminals 42 located in the individual sectors 170.

With respect to each beam centering control interval and selecting the beam center target 46 to use for centering each spot beam, the involved processing circuitry of the SCS 20 is, in one or more embodiments, configured to select a location in the corresponding nominal beam coverage area 40 in dependence on at least one of: a spatial distribution of the corresponding plurality of user terminals 42 within the corresponding nominal beam coverage area 40, or respective communication needs of the corresponding plurality of user terminals 42 within the corresponding nominal beam coverage area 40.

For example, the involved processing circuitry is configured to follow a pattern of location selection within each corresponding nominal beam coverage area 40 over multiple ones of the beam centering control intervals, where the pattern is a function of a user scheduling algorithm implemented by the SCS 20.

In one or more embodiments, the involved processing circuitry is configured to identify clusters of user terminals 42 within each nominal beam coverage area 40, and, over time, select different locations 44 corresponding to different identified clusters as the beam center target 46 for the spot beam 10 corresponding to the nominal beam coverage area 40.

The involved processing circuitry is, in at least one embodiment, configured to align boundaries of the beam centering control intervals with boundaries of transmission slots used by the SCS for transmissions of user traffic. Doing so restricts movement of the beam center 14 of any spot beam 10 among the plurality of spot beams 10 to occur only on transmission slot boundaries.

The involved processing circuitry in one or more embodiments is configured to move beam centers 14 of the plurality of spot beams 10 by, during any current beam centering control interval, selecting a next beam center target 46 for each spot beam 10 with respect to a next beam centering control interval and, for any spot beam 10 in which the next beam center target 46 selected for the next beam centering control interval differs from a current beam center target 46 selected for the current beam centering interval, adjusting beamforming performed by the SCS 20 at the beginning of the next beam centering control interval to move the beam center 14 of the spot beam 10 to the next beam center target 46.

To move the beam center 14 of any one among the plurality of spot beams 10, the involved processing circuitry is, in one or more embodiments, configured to compute new values for a corresponding set of beamforming weights used by the SCS 20 to produce signal superpositions resulting in the spot beam 10. Thus, in one or more embodiments, the SCS 20 is configured to use beamforming to provide the plurality of spot beams 10, with the SCS 20 computing and applying beamforming weights to its transmissions of user traffic, to realize the respective spot beams 10. As noted, in at least such embodiment, the SCS 20 is configured to perform end-to-end beamforming in the forward direction, wherein the plurality of spot beams 10 comprises a plurality of forward user beams 100.

In at least one embodiment, the one or more satellites 28 comprise a satellite 28 having a phased array antenna 140 used to provide the plurality of forward user beams 100. The corresponding beamforming weights are computed onboard the satellite 28 or are computed in the ground segment 22. For example, the processing circuitry used to implement the dynamic beam centering function 32 may be implemented in the ground segment 22 and be configured to transmit or cause transmission of the dynamically computed beamforming weights to the satellite 28 as a forward uplink transmission from one of the one or more SANs 24.

In at least one embodiment, the involved processing circuitry is configured to, for each forward user beam 100 for which the corresponding beam center 14 is moved to a new beam center target 46, compute new values for the corresponding set of beamforming weights.

The new values are computed to optimize a SNR at the new beam center target 46, and to minimize other-beam interference at the new beam center target 46. The processing circuitry in one or more embodiments is configured to account for changes in inter-beam interference arising from moved beam centers 14, when computing new values of the beamforming weights.

Broadly, the present disclosure details techniques for dynamic recentering of spot beams 10, such that, over time, different locations within the corresponding nominal beam coverage areas 40 experience maximum beam signal power. For example, the SCS 20 uses beam centering to improve SNR for scheduled user terminals 42. In the context of fixed coverage areas where the beam center of a conventional beam remains fixed-absent unintentional perturbations-dynamic recentering of the beam as a component of user scheduling yields significant improvements in beam/system throughput.

In one example, the SCS 20 implements end-to-end beamforming in the forward direction using a geosynchronous satellite 28 as an end-to-end relay between a plurality of geographically distributed SANs 24 and a population of user terminals 42 distributed over an aggregate service area 106 illuminated by a plurality of forward user beams 100. Processing circuitry 66 in the ground segment 22 of the SCS 20 dynamically selects locations 44 within the forward user beam coverage areas 104 corresponding to the forward user beams 100 for use in determining corresponding beam center targets 46 for an upcoming beam centering control interval and updates the beamforming solution used by the SCS 20 for realization of the forward user beams 100.

In other example of ground-based beamforming, the ground segment 22 of the SCS 20 forms beam signals corresponding to the forward user beams 100 and splits each such forward beam signal into a plurality of forward beam element signals. The forward beam element signals are weighted for transmission from respective antenna elements 142 of a phased array antenna 140 onboard the satellite 28. Correspondingly, the ground segment 22 transmits one or more forward uplink signals 132 that convey the forward beam element signals for the various forward beam signals to the satellite 28 for recovery and corresponding transmission from the phased array antenna 140. That transmission produces the desired plurality of forward user beams 100.

In yet another alternative, the satellite receives the forward beam signals and generates the corresponding forward beam element signals, for transmission from one or more onboard phased array antennas 140. As a further variation in this embodiment, the beamforming solution used to create the forward beam element signals may be computed in the ground segment 22 and transmitted to the satellite 28, or the satellite 28 may compute the beamforming solution. That is, in at least one embodiment, processing circuitry configured to implement the beam centering function 32 is onboard the satellite 28, and the satellite 28 updates the beamforming solution to reflect updated beam center targets 46.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-36. (canceled)

37. A method of satellite beam control for a satellite communications system comprising one or more satellite access nodes and one or more satellites, the method comprising:
providing a plurality of spot beams, each spot beam serving a corresponding plurality of user terminals and having a corresponding nominal beam coverage area; and
moving beam centers of the plurality of spot beams with respect to the corresponding nominal beam coverage areas as a component of user scheduling by the satellite communications system, based on, with respect to each spot beam and with respect to each beam centering control interval in a succession of beam centering control intervals, selecting a beam center target to use for centering the spot beam, the beam center target corresponding to a location in the corresponding nominal beam coverage area.

38. The method according to claim 37, wherein the one or more satellites comprise a geostationary satellite used to provide the plurality of spot beams as nominally stationary spot beams corresponding to the nominal beam coverage areas.

39. The method according to claim 37, wherein the corresponding nominal beam coverage area of each spot beam is logically divided into a plurality of sectors, and wherein the beam center target for each spot beam in each beam centering control interval corresponds to a selected one of the sectors.

40. The method according to claim 39, further comprising selecting the sectors on a round-robin basis, and, with respect to each round-robin selection cycle, controlling the length of time individual ones of the sectors remain selected based on communication needs of user terminals located in the individual sectors.

41. The method according to claim 37, wherein, with respect to each beam centering control interval, selecting the beam center target to use for centering each spot beam comprises selecting a location in the corresponding nominal beam coverage area in dependence on at least one of: a spatial distribution of the corresponding plurality of user terminals within the corresponding nominal beam coverage area; or respective communication needs of the corresponding plurality of user terminals within the corresponding nominal beam coverage area.

42. The method according to claim 41, wherein a pattern of location selection within each corresponding nominal beam coverage area over multiple ones of the beam centering control intervals is a function of a user scheduling algorithm implemented by the satellite communications system.

43. The method according to claim 41, further comprising identifying clusters of user terminals within each nominal beam coverage area, and, over time, selecting different locations corresponding to different identified clusters as the beam center target for the spot beam corresponding to the nominal beam coverage area.

44. The method according to claim 37, further comprising aligning boundaries of the beam centering control intervals with boundaries of transmission slots used by the satellite communications system for transmissions of user traffic, such that movement of the beam center of any spot beam among the plurality of spot beams occurs only on transmission slot boundaries.

45. The method according to claim 37, wherein moving beam centers of the plurality of spot beams comprises, during any current beam centering control interval, selecting a next beam center target for each spot beam with respect to a next beam centering control interval and, for any spot beam in which the next beam center target selected for the next beam centering control interval differs from a current beam center target selected for the current beam centering interval, adjusting beamforming performed by the satellite communications system at the beginning of the next beam centering control interval to move the beam center of the spot beam to the next beam center target.

46. The method according to claim 37, wherein moving the beam center of any one among the plurality of spot beams comprises computing new values for a corresponding set of beamforming weights used by the satellite communications system to produce signal superpositions resulting in the spot beam.

47. The method according to claim 37, wherein the satellite communications system performs beamforming to provide the plurality of spot beams, each spot beam having a corresponding set of beamforming weights used by the satellite communications system.

48. The method according to claim 47, wherein the satellite communications system performs end-to-end beamforming in the forward direction, wherein the plurality of spot beams comprises a plurality of forward user beams.

49. The method according to claim 48, wherein, for each forward user beam for which the corresponding beam center is moved to a new beam center target, the method includes computing new values for the corresponding set of beamforming weights, wherein the new values are computed to optimize a signal-to-noise ratio (SNR) at the new beam center target, and to minimize other-beam interference at the new beam center target.

50. The method according to claim 49, wherein, for any beam centering control interval for which one or more beam centers are moved, the method comprises computing new values for all beamforming weights, to account for changes in inter-beam interference arising from the moved beam centers.

51. The method according to claim 47, wherein the one or more satellites comprise a satellite having a phased array antenna used to provide the plurality of spot beams as a plurality of forward user beams, and wherein the corresponding beamforming weights are computed onboard the satellite or are computed in a ground segment of the satellite communications system and conveyed to the satellite as a forward uplink transmission from one of the one or more satellite access nodes.

52. The method according to claim 37, wherein the duration of the beam centering control intervals is an integer multiple of the duration of user scheduling intervals used by the satellite communications system, and wherein boundaries of the beam centering control intervals align with boundaries of the user scheduling intervals.

53. The method according to claim 37, wherein the beam center targets for individual ones among the plurality of spot beams are selected independently.

54. The method according to claim 37, further comprising applying spatial limits to the selection of beam center targets, to restrict spot beam overlap between adjacent spot beams that are at a same frequency.

55. A satellite communications system comprising:
a ground segment comprising one or more satellite access nodes; and
a space segment comprising one or more satellites;
wherein the one or more satellite access nodes and the one or more satellites are configured to cooperate to provide a plurality of spot beams, each spot beam serving a corresponding plurality of user terminals and having a corresponding nominal beam coverage area; and
wherein processing circuitry comprised in the satellite communications system is configured to move beam centers of the plurality of spot beams with respect to the corresponding nominal beam coverage areas as a component of user scheduling by the satellite communications system, based on, with respect to each spot beam and with respect to each beam centering control interval in a succession of beam centering control intervals, selecting a beam center target to use for centering the spot beam, the beam center target corresponding to a location in the corresponding nominal beam coverage area.

56. The satellite communications system according to claim 55, wherein the one or more satellites comprise a geostationary satellite used to provide the plurality of spot beams as nominally stationary spot beams corresponding to the nominal beam coverage areas.

57. The satellite communications system according to claim 55, wherein the corresponding nominal beam coverage area of each spot beam is logically divided into a plurality of sectors, and wherein the beam center target for each spot beam in each beam centering control interval corresponds to a selected one of the sectors.

58. The satellite communications system according to claim 57, wherein the processing circuitry is configured to select the sectors on a round-robin basis, and, with respect to each round-robin selection cycle, control the length of time individual ones of the sectors remain selected based on communication needs of user terminals located in the individual sectors.

59. The satellite communications system according to claim 55, wherein, with respect to each beam centering control interval and selecting the beam center target to use for centering each spot beam, the processing circuitry is configured to select a location in the corresponding nominal beam coverage area in dependence on at least one of: a spatial distribution of the corresponding plurality of user terminals within the corresponding nominal beam coverage area; or respective communication needs of the corresponding plurality of user terminals within the corresponding nominal beam coverage area.

60. The satellite communications system according to claim 59, wherein the processing circuitry is configured to follow a pattern of location selection within each corresponding nominal beam coverage area over multiple ones of the beam centering control intervals that is a function of a user scheduling algorithm implemented by the satellite communications system.

61. The satellite communications system according to claim 59, wherein the processing circuitry is configured to identify clusters of user terminals within each nominal beam coverage area, and, over time, select different locations corresponding to different identified clusters as the beam center target for the spot beam corresponding to the nominal beam coverage area.

62. The satellite communications system according to claim 55, wherein the processing circuitry is configured to align boundaries of the beam centering control intervals with boundaries of transmission slots used by the satellite communications system for transmissions of user traffic, such that movement of the beam center of any spot beam among the plurality of spot beams occurs only on transmission slot boundaries.

63. The satellite communications system according to claim 55, wherein the processing circuitry is configured to move beam centers of the plurality of spot beams by, during any current beam centering control interval, selecting a next beam center target for each spot beam with respect to a next beam centering control interval and, for any spot beam in which the next beam center target selected for the next beam centering control interval differs from a current beam center target selected for the current beam centering interval, adjusting beamforming performed by the satellite communications system at the beginning of the next beam centering control interval to move the beam center of the spot beam to the next beam center target.

64. The satellite communications system according to claim 55, wherein, to move the beam center of any one among the plurality of spot beams, the processing circuitry is configured to compute new values for a corresponding set of beamforming weights used by the satellite communications system to produce signal superpositions resulting in the spot beam.

65. The satellite communications system according to claim 55, wherein the satellite communications system is configured to use beamforming to provide the plurality of spot beams, each spot beam having a corresponding set of beamforming weights used by the satellite communications system.

66. The satellite communications system according to claim 65, wherein the satellite communications system is configured to perform end-to-end beamforming in the forward direction, wherein the plurality of spot beams comprises a plurality of forward user beams.

67. The satellite communications system according to claim 66, wherein the processing circuitry is configured to, for each forward user beam for which the corresponding beam center is moved to a new beam center target, compute new values for the corresponding set of beamforming weights, wherein the new values are computed to optimize a signal-to-noise ratio (SNR) at the new beam center target, and to minimize other-beam interference at the new beam center target.

68. The satellite communications system according to claim 67, wherein, for any beam centering control interval for which one or more beam centers are moved, the processing circuitry is configured to compute new values for all beamforming weights, to account for changes in inter-beam interference arising from the moved beam centers.

69. The satellite communications system according to claim 65, wherein the one or more satellites comprise a satellite having a phased array antenna used to provide the plurality of forward user beams, and wherein the corresponding beamforming weights are computed onboard the satellite or are computed via the processing circuitry comprised in the ground segment, in which case the processing circuitry is configured to cause transmission of the corresponding beamforming weights to the satellite as a forward uplink transmission from one of the one or more satellite access nodes.

70. The satellite communications system according to claim 55, wherein the duration of the beam centering control intervals is an integer multiple of the duration of user scheduling intervals used by the satellite communications system, and wherein boundaries of the beam centering control intervals align with boundaries of the user scheduling intervals.

71. The satellite communications system according to claim 55, wherein the processing circuitry is configured to select the beam center targets for individual ones among the plurality of spot beams independently.

72. The satellite communications system according to claim 55, wherein the processing circuitry is configured to apply spatial limits to the selection of beam center targets, to restrict spot beam overlap between adjacent spot beams that are at a same frequency.
